(19) United States
(12) Patent Application Publication
(10) Pub. No.: US 2025/0253799 A1
(43) Pub. Date: Aug. 7, 2025

(54) Portable Solar Farm

(71) Applicant: Jesus Rene Villalobos, Mesa, AZ (US)

(72) Inventor: Jesus Rene Villalobos, Mesa, AZ (US)

(21) Appl. No.: 18/930,485

(22) Filed: Oct. 29, 2024

Related U.S. Application Data
(60) Provisional application No. 63/594,003, filed on Oct. 29, 2023.

(51) Int. Cl. H02S 10/40; G05D 3/10; H02S 20/32; H02S 30/10; H02S 30/20

(52) U.S. Cl. CPC H02S 10/40; G05D 3/105; H02S 20/32; H02S 30/10; H02S 30/20

(57) ABSTRACT

A portable solar farm may comprise a plurality of solar panels and a collapsible frame coupled to the solar panels. The collapsible frame may be configured to collapse into a compact configuration for storage or transport. The collapsible frame may also be configured to expand to arrange the plurality of solar panels at a common angle for power generation. A wheel system may be coupled to the collapsible frame to facilitate transport of the portable solar farm. The portable solar farm may include a locking mechanism configured to secure the collapsible frame in an expanded position. At least one actuator may be coupled to the collapsible frame. A control system may be configured to operate the actuator to adjust an expansion of the collapsible frame. The control system may determine a geographic location of the portable solar farm and calculate an optimal angle for the solar panels based on the location.

### CROSS-REFERENCE TO RELATED APPLICATIONS

Under provisions of 35 U.S.C. § 119(e), this application claims the benefit of U.S. Provisional Application No. 63/594,003, filed Oct. 29, 2023, the entire contents of which are hereby incorporated by reference.

### BACKGROUND

Solar energy systems are widely used for generating electrical power. However, conventional large-scale solar farms are typically permanent installations that require significant space and infrastructure. Portable solar generators exist, but are often limited in capacity or require extensive manual adjustment. There remains a need for improved portable solar energy solutions that can provide substantial power generation capabilities while allowing for easy transport and deployment.

### SUMMARY

The present disclosure relates generally to portable solar energy systems. More specifically, embodiments described herein provide a collapsible and expandable portable solar farm that can be readily transported and deployed to generate electrical power in remote or temporary locations.

In one aspect, a portable solar farm is provided that includes a plurality of solar panels, a collapsible frame, and a wheel system. The collapsible frame allows the solar panels to be compactly stored for transport and expanded for deployment. When expanded, the frame positions the solar panels at a common angle for optimal sun exposure.

In some embodiments, the portable solar farm may include automated systems for adjusting panel positioning based on location, time, and sun position. The system may be particularly well-suited for providing power to refrigerated shipping containers or other temporary power needs in remote agricultural settings or disaster relief scenarios.

The foregoing summary is illustrative only and is not intended to be in any way limiting. In addition to the illustrative aspects, embodiments, and features described above, further aspects, embodiments, and features will become apparent by reference to the drawings and the following detailed description. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. The accompanying drawings, which are incorporated in and constitute a part of this disclosure, illustrate various embodiments of the present disclosure. The drawings contain representations of various trademarks and copyrights owned by the Applicant.

In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure.

In the drawings:

FIG. 1 is a perspective view of an exemplary portable solar farm in an expanded configuration, in accordance with embodiments of the present disclosure.

FIG. 2 is a side view of the exemplary portable solar farm of FIG. 1 in a collapsed configuration for transport or storage, in accordance with embodiments of the present disclosure.

FIG. 3 is a perspective view of an exemplary swivel wheel assembly of an exemplary portable solar farm in an expanded configuration, in accordance with embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

Reference will now be made in detail to embodiments of the present disclosure, examples of which are illustrated in the accompanying drawings. Wherever possible, the same reference numbers will be used throughout the drawings to refer to the same or like parts. The present invention can be understood more readily by reference to the following detailed description of the invention and the examples included therein. Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described. All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result. All publications mentioned herein are incorporated herein by reference to disclose and describe the methods and/or materials in connection with which the publications are cited.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header. In the following detailed description, reference is made to the accompanying drawings, which form a part hereof. In the drawings, similar symbols typically identify similar components, unless context dictates otherwise.

The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, separated, and designed in a wide variety of different configurations, all of which are explicitly contemplated herein. The present disclosure is directed to portable solar farm systems that can be readily transported, deployed, and adjusted to generate electrical power in various locations and conditions. While specific examples may be provided, the disclosure is not limited to these particular embodiments. The principles described herein may be applied to a wide range of portable solar energy applications beyond those explicitly discussed.

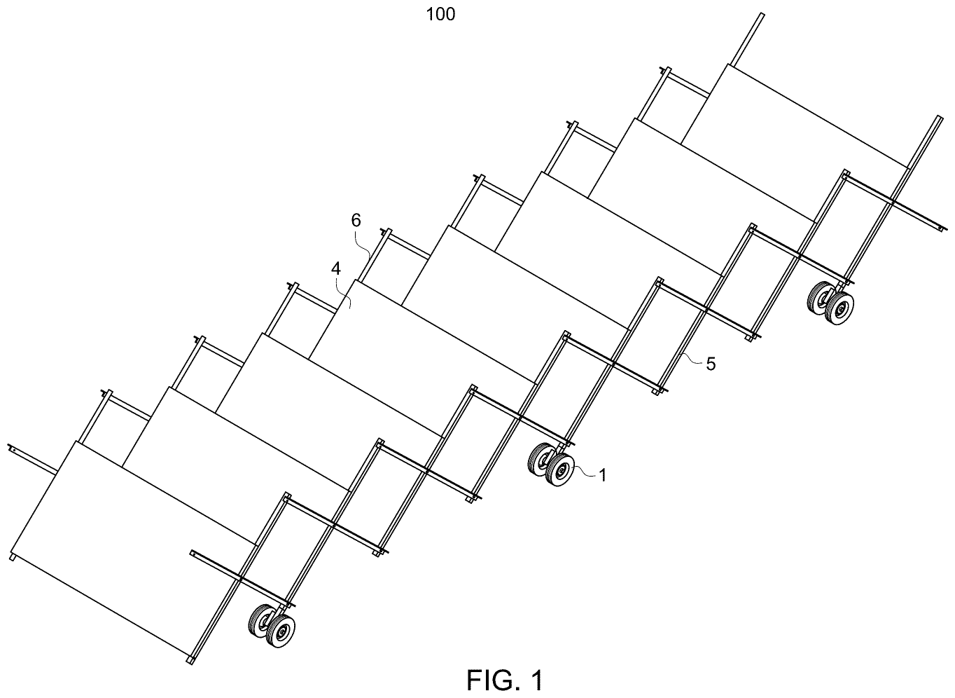

Referring now to FIG. 1, an exemplary portable solar farm 100 is shown in an expanded configuration for operation. The portable solar farm 100 includes a plurality of solar panels 4 mounted on a collapsible frame. The frame comprises left panel scissor arms 5 and right panel scissor arms 6 arranged in an accordion-like structure. This configuration allows the frame to expand and collapse while maintaining the solar panels 4 in a parallel arrangement.

The portable solar farm 100 is supported by a wheel system that includes wheels 1 attached to the base of the frame. The wheels 1 enable easy transport of the system when in its collapsed state and allow for positioning during deployment. In some embodiments, the wheels 1 may include locking mechanisms to secure the system in place during operation.

The frame of the portable solar farm 100 may be constructed using lightweight yet durable materials such as aluminum or reinforced polymers. Conventional fasteners such as bolts, nuts, and hinges may be used to assemble the components of the frame while allowing for the folding and unfolding motion.

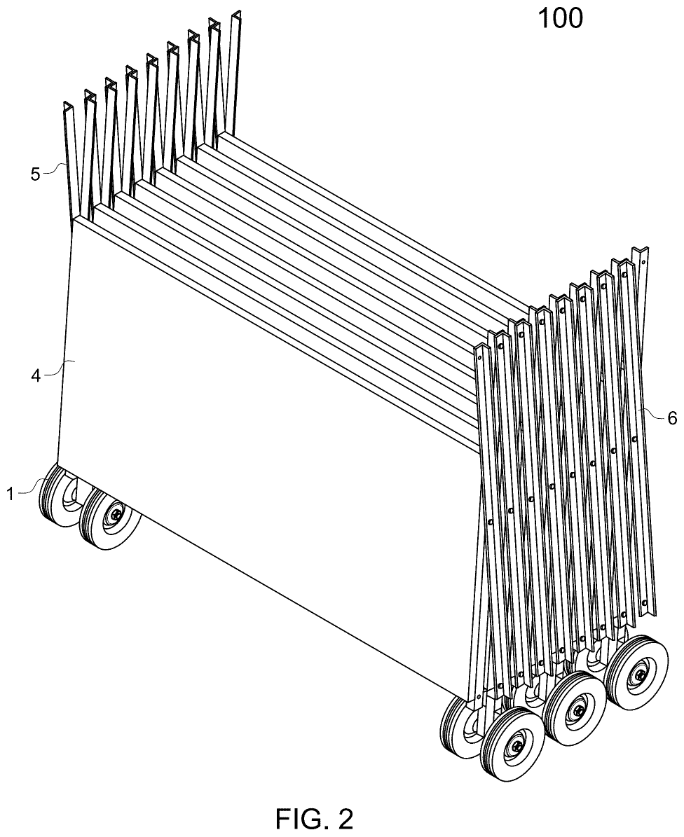

FIG. 2 illustrates the portable solar farm 100 in its collapsed configuration for storage or transport. In this state, the solar panels 4 and frame components are compactly folded, significantly reducing the overall footprint of the system. The wheels 1 remain accessible, allowing the collapsed unit to be easily moved like a wheeled cart or dolly.

The collapsible nature of the frame allows for efficient storage and transport of the portable solar farm 100. When needed, the system can be quickly expanded to its operational configuration as shown in FIG. 1. This expandability feature is particularly advantageous for temporary power needs or in locations where permanent solar infrastructure is not feasible.

In operation, the portable solar farm 100 may be deployed by first positioning the collapsed unit at the desired location. The frame is then expanded, which simultaneously arranges all of the solar panels 4 at a common angle. The optimal angle for the solar panels 4 can vary based on geographic location (latitude) and time of year.

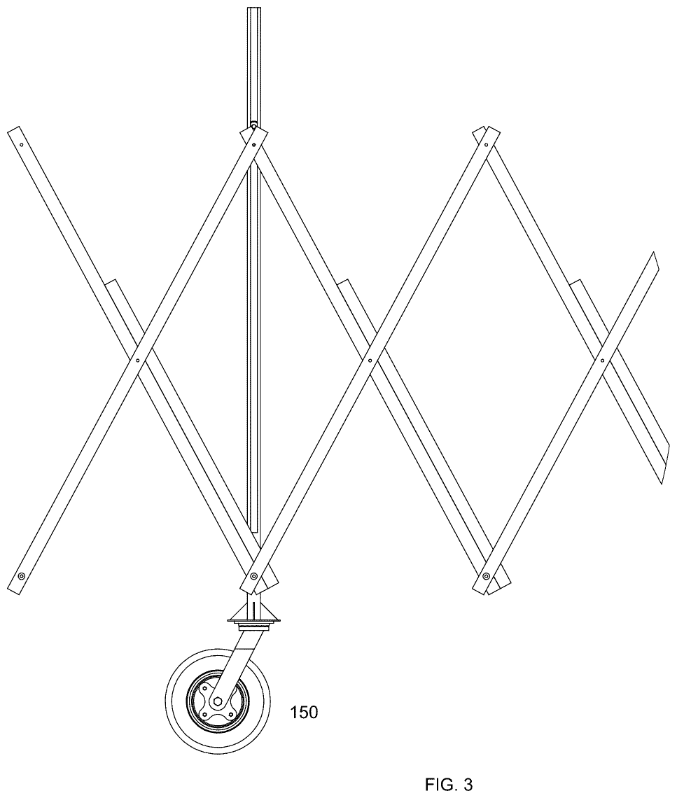

In some embodiments, the expansion of the frame may be performed manually, with the user adjusting the expansion until the desired panel angle is achieved. This may be done through trial and error or by calculating the appropriate expansion distance based on the required angle. One possible embodiment of the invention may be provided by the Freshkube™ suite of products and services provided by Freshkube Inc. In one or more embodiments, this adjustment is achieved by having a swivel wheel, as shown in FIG. 3, 150. This may allow the frame to be adjusted manually or automatically allowing the whole array to be rotated while extended.

Alternative embodiments may incorporate automated expansion and positioning systems. For example, the portable solar farm 100 may include servo motors or other actuators coupled to the frame. A control system, which may include a microcomputer or microcontroller, can be used to operate these actuators. The control system may utilize GPS data to determine the current location and automatically calculate and set the optimal panel angle.

Further automation may include sun-tracking capabilities, including but not limited to the use of photo sensors, where the control system adjusts the orientation of the entire portable solar farm 100 throughout the day to maximize solar exposure. This may involve rotating the system on its wheels or incorporating additional pivoting mechanisms in the frame.

The solar panels 4 are electrically connected to form an array capable of generating substantial power output. The specific wiring configuration may vary based on the intended application, but generally allows for a single connection point to power the target devices or charge batteries.

While a primary application of the portable solar farm 100 may be powering refrigerated shipping containers for agricultural products, the system is adaptable to various temporary and permanent power needs. Examples include providing electricity for disaster relief efforts, outdoor events, or remote construction sites.

Safety features may be incorporated into the portable solar farm 100 design. For instance, the control system (when present) may monitor weather conditions and automatically retract or rotate the panels to a safe position in case of high winds or other hazardous conditions. Manual retraction for storage or safety can also be performed quickly due to the accordion-like frame design.

The electrical connections and components of the portable solar farm 100 may be designed for ease of use, potentially allowing deployment without requiring a professional electrician. However, it is understood that local regulations and safety standards should always be followed when installing and operating electrical systems.

Variations of the portable solar farm 100 may include different sizes or configurations to suit various power needs and transportation requirements. The principles of the collapsible frame and adjustable panel positioning can be scaled or modified while maintaining the core functionality of the system.

The portable solar farm 100 represents an advancement in mobile solar energy solutions, offering a balance of substantial power generation capability with the flexibility of easy transport and deployment. Its design addresses the limitations of both large-scale fixed solar farms and smaller portable solar generators, providing a versatile solution for temporary or remote power needs.

The method of use for the portable solar farm may include the following steps:
a. Transporting the collapsed solar farm to the desired deployment location. The collapsed configuration allows for easy transport using the integrated wheel system.
b. Positioning the collapsed solar farm at the deployment site. The wheels may be locked in place to secure the system.
c. Expanding the collapsible frame to deploy the solar panels. This may be done manually or using an automated system if equipped.
d. Adjusting the expansion of the frame to achieve the optimal angle for the solar panels based on the geographic location and time of year. This may involve:
   1. Manually measuring and adjusting the frame expansion.
   2. Using a control system to automatically calculate and set the optimal angle.
   3. Adjusting during the day using swivel wheels either manually or using an automatic servo motor.
e. rotating the expanded solar farm according to the time of the day to capture the maximum sunlight.
f. Orienting the entire solar farm to face the optimal direction, typically southward in the northern hemisphere.
g. Electrically connecting the solar farm output to the intended power storage or consumption devices, such as batteries or mini refrigerated containers.
h. Periodically adjusting the orientation of the solar farm throughout the day to track the sun's movement, if this capability is implemented. This may be done manually or automatically.
i. Monitoring the power output and environmental conditions during operation.

In case of adverse weather conditions:
a. Manually retracting the frame to collapse the solar panels for protection.
b. Allowing an automated system to detect conditions and retract the panels.

At the end of the deployment period:
a. Disconnecting the electrical connections.
b. Collapsing the frame back into its compact configuration.
c. Preparing the system for transport to storage or the next deployment location.
d. Performing any necessary maintenance on the frame, panels, electrical components, or control systems between deployments.

This method of use allows for flexible deployment of solar power generation in temporary or remote locations without requiring permanent infrastructure installation. The system's portability and ease of setup make it suitable for various applications, from powering agricultural equipment to providing emergency power in disaster relief situations.

The operating environment for the portable solar farm may include various outdoor locations where temporary or remote power generation is required. These environments may range from agricultural fields to disaster relief areas, construction sites, or outdoor events. The system may be deployed in areas with limited or no access to traditional power infrastructure. The terrain may vary from flat surfaces to slightly uneven ground, as long as it can accommodate the wheel system and provide stability for the expanded frame.

The solar farm may operate in various climate zones, from temperate to tropical regions, as long as there is sufficient sunlight for power generation. The system's performance may be optimized based on the specific geographic location and seasonal variations in sun position. Weather conditions in the operating environment may fluctuate, potentially including sunny, cloudy, or windy conditions. The system may need to withstand moderate environmental stresses while in operation, such as light wind or rain. However, in cases of severe weather, the system may be designed to be quickly collapsed for protection.

In terms of physical space requirements, the operating environment should provide enough open area to partially and fully expand the solar panel array and allow for potential repositioning throughout the day to track the sun's movement. The exact space needed may depend on the specific size and capacity of the portable solar farm model. The system may interface with various power storage or consumption devices in its operating environment. This could include batteries, power inverters, or direct connections to electrical equipment such as refrigeration units, lighting systems, or other temporary power needs.

Safety considerations in the operating environment may include ensuring proper grounding, protecting against electrical hazards, and securing the system against tipping or movement during operation. The area around the deployed solar farm may need to be clearly marked or cordoned off to prevent accidental interference or damage. Maintenance activities may also be performed in the operating environment, such as cleaning the solar panels, inspecting the frame and electrical connections, or making minor repairs. The system may be designed to facilitate these activities without requiring specialized equipment or facilities.

Overall, the portable solar farm may be engineered to adapt to a wide range of outdoor operating environments, balancing the need for power generation with the constraints of temporary or remote deployment scenarios. The portable solar farm system may provide several technical advantages over existing solutions for temporary or remote solar power generation. These advantages may include:
1. Improved portability and ease of deployment: The collapsible accordion-style frame may allow the system to be compactly stored and transported, while enabling quick expansion at the deployment site. This design may bridge the gap between small portable units and large fixed solar farms.
2. Efficient panel positioning: The folding frame design may ensure all panels remain parallel when expanded, potentially allowing for a single adjustment to optimize the angle of the entire array. This may simplify deployment and increase overall system efficiency compared to manually adjusting individual panels.
3. Enhanced adaptability: The ability to rapidly collapse and expand the array may allow for quick protection from harsh weather conditions like strong winds or hail. This feature, especially if automated, may significantly enhance the durability and longevity of the system in varying environmental conditions.
4. Simplified operation: The accordion-style frame may allow for intuitive deployment without requiring specialized knowledge. Potential one-touch automated expansion and retraction may further simplify operation for non-expert users.
5. Scalability: The modular design may allow for easy scaling of the system by adding or removing panel sections as needed for different power requirements.
6. Integrated mobility: The built-in wheel system may facilitate easy repositioning of the entire array without disassembly.
7. Optimized sun tracking: The potential for automated expansion and orientation adjustment based on GPS location and time may maximize power generation throughout the day without manual intervention.
8. Rapid setup and teardown: The collapsible design and integrated electrical connections may allow for swift deployment and packing, reducing setup and teardown times compared to traditional portable solar solutions.
9. Versatility: The system may be suitable for various temporary power needs like agricultural refrigeration, disaster relief, and remote construction sites, balancing substantial power generation with portability.
10. Cost-effectiveness: By enabling temporary solar power without permanent installation, the system may provide a more economical solution for short-term or intermittent power needs in remote locations.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entirety are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application. It should be understood that the above-described embodiments are merely possible examples of implementations, merely set forth for a clear understanding of the principles of the present disclosure. Many variations and modifications may be made to the above-described embodiments without departing substantially from the spirit and principles of the disclosure. All such modifications and variations are intended to be included herein within the scope of this disclosure and protected by the following claims.

What is claimed is:

1. A portable solar farm comprising:
a plurality of solar panels;
a collapsible frame coupled to the plurality of solar panels the collapsible frame configured to:
collapse into a compact configuration for storage or transport, and
expand to arrange the plurality of solar panels at a common angle for power generation; and
a wheel system coupled to the collapsible frame to facilitate transport and operation of the portable solar farm.

2. The portable solar farm of claim 1, further comprising a locking mechanism configured to secure the collapsible frame in any expanded position.

3. The portable solar farm of claim 1, further comprising:
at least one actuator coupled to the collapsible frame; and
a control system configured to operate the at least one actuator to adjust an expansion of the collapsible frame.

4. The portable solar farm of claim 3, wherein the control system is further configured to:
determine a geographic location of the portable solar farm;
calculate an optimal angle for the plurality of solar panels based on the geographic location; and
control the at least one actuator to expand the collapsible frame until the common angle of the solar panels reaches the calculated optimal angle.

5. The portable solar farm of claim 3, wherein the control system is further configured to:
monitor weather conditions; and
automatically retract the collapsible frame in response to detected adverse weather conditions.

6. The portable solar farm of claim 3, wherein the control system is further configured to adjust an orientation of the portable solar farm to track movement of the sun.

7. The portable solar farm of claim 1, wherein the collapsible frame comprises a plurality of interconnected scissor arms arranged in an accordion-like configuration.

8. The portable solar farm of claim 1, further comprising an electrical connection system configured to electrically couple the plurality of solar panels to form a solar array with a single power output connection.

9. The portable solar farm of claim 1, wherein the wheel system comprises locking wheels configured to secure the portable solar farm in a stationary position during operation.

10. A method of deploying a portable solar farm, the method comprising:
transporting a portable solar farm to a deployment location, the portable solar farm comprising a plurality of solar panels mounted on a collapsible frame;
expanding the collapsible frame from a compact configuration to an expanded configuration, wherein expanding the collapsible frame simultaneously arranges the plurality of solar panels at a common angle; and
electrically connecting the portable solar farm to a power storage or consumption device.

11. The method of claim 10, further comprising:
determining an optimal angle for the plurality of solar panels based on at least one of a geographic location of the deployment location or a current date; and
adjusting an expansion of the collapsible frame to achieve the optimal angle for the plurality of solar panels.

12. The method of claim 11, wherein determining the optimal angle and adjusting the expansion of the collapsible frame are performed automatically by a control system of the portable solar farm.

13. The method of claim 10, further comprising:
monitoring environmental conditions at the deployment location; and
automatically retracting the collapsible frame in response to detected adverse environmental conditions.

14. The method of claim 10, further comprising periodically adjusting an orientation of the portable solar farm to track movement of the sun throughout a day.

15. A system for providing temporary solar power, the system comprising:
a portable solar farm including:
a plurality of solar panels,
a collapsible frame supporting the plurality of solar panels, the collapsible frame configured to expand from a compact configuration to position the plurality of solar panels at a common angle, and
a wheel system for transporting the portable solar farm; and
at least one power storage or consumption device electrically coupled to the portable solar farm.

16. The system of claim 15, wherein the at least one power storage or consumption device comprises a refrigerated shipping container.

17. The system of claim 15, further comprising a control system configured to:
determine a geographic location of the portable solar farm;
calculate an optimal angle for the plurality of solar panels based on the geographic location and a current date; and
control an expansion of the collapsible frame to achieve the calculated optimal angle.

18. The system of claim 17, wherein the control system is further configured to adjust an orientation of the portable solar farm throughout a day to track movement of the sun.

19. The system of claim 15, wherein the collapsible frame comprises a plurality of interconnected scissor arms arranged in an accordion-like configuration, the accordion-like configuration enabling simultaneous adjustment of angles for all solar panels in the plurality of solar panels.

20. The system of claim 15, wherein the portable solar farm is configured to be deployed and begin power generation without requiring services of a professional electrician.
